(19) United States
(12) Patent Application Publication
(10) Pub. No.: US 2015/0000301 A1
(43) Pub. Date: Jan. 1, 2015

(54) SYSTEM AND METHOD FOR MODELING BOTTOMING CYCLE PERFORMANCE OF A COMBINED CYCLE POWER PLANT

(71) Applicant: General Electric Company, Schenectady, NY (US)

(72) Inventor: John Edward Sholes, Kings Mountain, NC (US)

(21) Appl. No.: 13/932,196

(22) Filed: Jul. 1, 2013

(51) Int. Cl. F02C 6/02

(52) U.S. Cl. CPC F02C 6/02
USPC 60/783; 60/39.182

(57) ABSTRACT

A bottoming cycle modeling system for a combined cycle power plant includes one or more measurement devices configured and disposed to measure energy of exhaust gases passing from a gas turbine portion, one or more measurement devices configured and disposed to measure at least one bottoming cycle parameter of the combined cycle power plant, and a modeling system configured and disposed to calculate bottoming cycle performance based on the at least one output parameter of the gas turbine portion and the at least one bottoming cycle parameter. The modeling system employs a model that provides a substantially fully robust solution in approximately real time.

### BACKGROUND OF THE INVENTION

The subject matter disclosed herein relates to the art of combined cycle power plants and, more particularly, to a system and method for modeling bottoming cycle performance of a combined cycle power plant.

A combined cycle power plant uses both gas and steam turbines to generate the total plant power output. The gas turbine may be considered the primary power source. Exhaust (waste heat) from the gas turbine is used to generate steam that powers the steam turbine, which generates additional power as a secondary source. Existing systems control operation of the gas turbine, the steam turbine, or other plant subsystems to affect plant performance without considering the interrelationship between the gas turbine and the steam turbine. Further, existing systems employ iterative mathematical models that require an unacceptable time period to converge to a solution, do not always converge to a solution or provide solutions having an unacceptable level of accuracy.

### BRIEF DESCRIPTION OF THE INVENTION

According to one aspect of an exemplary embodiment, a bottoming cycle modeling system for a combined cycle power plant includes one or more measurement devices configured and disposed to measure energy of exhaust gases passing from a gas turbine portion, one or more measurement devices configured and disposed to measure at least one bottoming cycle parameter of the combined cycle power plant, and a modeling system configured and disposed to calculate bottoming cycle performance based on the at least one output parameter of the gas turbine portion and the at least one bottoming cycle parameter. The modeling system employs a model that provides a substantially fully robust solution in approximately real time.

According to another aspect of an exemplary embodiment, a combined cycle power plant includes a gas turbomachine including a compressor portion and a gas turbine portion, a steam turbomachine including at least one steam turbine portion, a heat recovery steam generator (HRSG) operatively connected to each of the gas turbine portion and the steam turbine portion, and a controller operatively connected to each of the gas turbomachine, steam turbomachine and the HRSG. The controller includes a bottoming cycle modeling system including one or more measurement devices configured and disposed to measure energy of exhaust gases passing from a gas turbine portion, one or more measurement devices configured and disposed to measure at least one bottoming cycle parameter, and a modeling system configured and disposed to calculate bottoming cycle performance based on the at least one output parameter of the gas turbine portion and the at least one bottoming cycle parameter. The modeling system employs a model that provides a substantially fully robust solution in approximately real time.

According to yet another aspect of an exemplary embodiment, a method of modeling bottoming cycle performance of a combined cycle power plant includes measuring energy of exhaust gases passing from a gas turbine portion, measuring at least one bottoming cycle parameter of the combined cycle power plant, and modeling bottoming cycle performance of the combined cycle power plant using a model that provides a substantially fully robust solution in approximately real time.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a combined cycle power plant having a controller including bottoming cycle performance modeling system in accordance with an exemplary embodiment;

FIG. 2 is a block diagram of the controller of FIG. 1;

FIG. 3 is a schematic representation of a model for modeling bottoming cycle performance employed by the controller in accordance with an exemplary embodiment; and

FIG. 4 is a flow chart illustrating a method of modeling bottoming cycle performance in accordance with an exemplary embodiment.

The detailed description explains embodiments of the invention, together with advantages and features, by way of example with reference to the drawings.

### DETAILED DESCRIPTION OF THE INVENTION

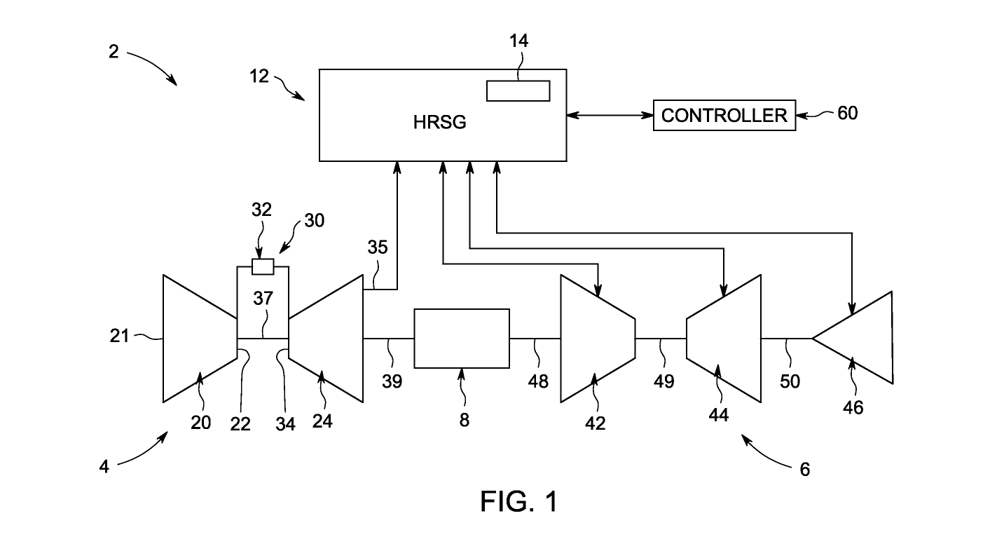

A combined cycle power plant (CCPP) in accordance with an exemplary embodiment is indicated generally at 2 in FIG. 1. CCPP 2 includes a gas turbomachine (GT) system 4 linked to a steam turbomachine (ST) system 6 through a generator 8. Of course it should be understood that GT system 4 could be linked to ST system 6 through other devices. GT system 4 and ST system 6 are also fluidically connected to a heat recovery steam generator (HRSG) 12. HRSG 12 includes a number of systems including a condenser 14. While shown as being arranged within HRSG 12, condenser 14 may also be mounted externally.

GT system 4 includes a compressor portion 20 having a compressor inlet 21 and a compressor outlet 22. GT system 4 also includes a gas turbine portion 24 and a combustor assembly 30. Combustor assembly 30 includes one or more combustors 32. Gas turbine portion 24 includes a turbine inlet 34 and a turbine outlet 35. Compressor portion 20 is linked to gas turbine portion 24 through a common compressor turbine shaft 37. Gas turbine portion 24 is linked to generator 8 through a shaft 39. Compressor portion 20 receives air through compressor inlet 21. The air passes through and is compressed by compressor portion 20. Compressed air exits compressor outlet 22 and passes to gas turbine portion 24 for cooling and to combustor assembly 32 to mix with fuel to form a combustible mixture. The combustible mixture is combusted in combustor assembly 30 to form products of combustion. The products of combustion pass to turbine inlet 34 via a transition piece (not shown). The products of combustion expand through gas turbine portion 24 creating work that drives generator 8. Exhaust gases pass from turbine outlet 35 to HRSG 12. Heat from the exhaust gases is employed to form steam that is passed to ST system 6.

ST system 6 includes a high pressure (HP) steam turbine portion 42, an intermediate pressure (IP) steam turbine portion 44 and a low pressure (LP) steam turbine portion 46. HP steam turbine portion 42 is mechanically linked to generator 8 through a shaft 48. HP steam turbine portion 42 is also mechanically linked to IP steam turbine portion 44 through a shaft 49. IP steam turbine portion 44 is mechanically linked to LP steam turbine portion 46 through a shaft 50. The particular connections between compressor portion 20, gas turbine portion 24, HP steam turbine portion 42, IP steam turbine portion 44, and LP steam turbine portion 46 forms a single shaft combined cycle power plant.

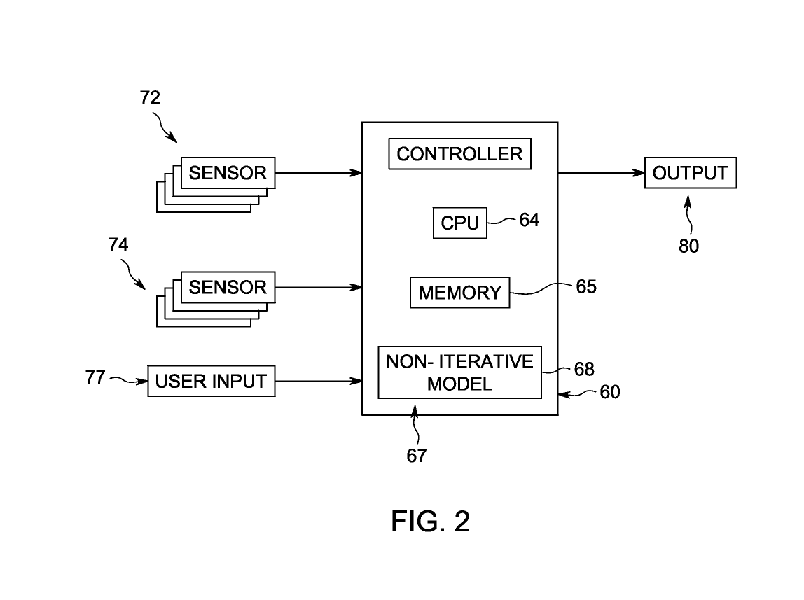

CCPP 2 is also shown to include a controller 60. Controller 60 monitors and adjusts various operating parameters of CCPP 2 based on user and sensor inputs. Controller 60 also models steam turbine power over a wide range of load and ambient conditions. As shown in FIG. 2, controller 60 includes a processor 64 and a memory 65. Controller 60 also includes a bottoming cycle modeling system 67 including a model 68 that may be stored in memory 65. In accordance with an aspect of the exemplary embodiment, model 68 arrives at a solution without iterations. More specifically, model 68, in accordance with an exemplary embodiment, is a non-iterative model. Controller 60 receives inputs from one or more GT system sensors 72, one or more ST system sensors 74, and/or user inputs 77. In addition to controlling CCPP 2 operating parameters based on the inputs, controller 60 provides an output 80 indicating ST system 6 power.

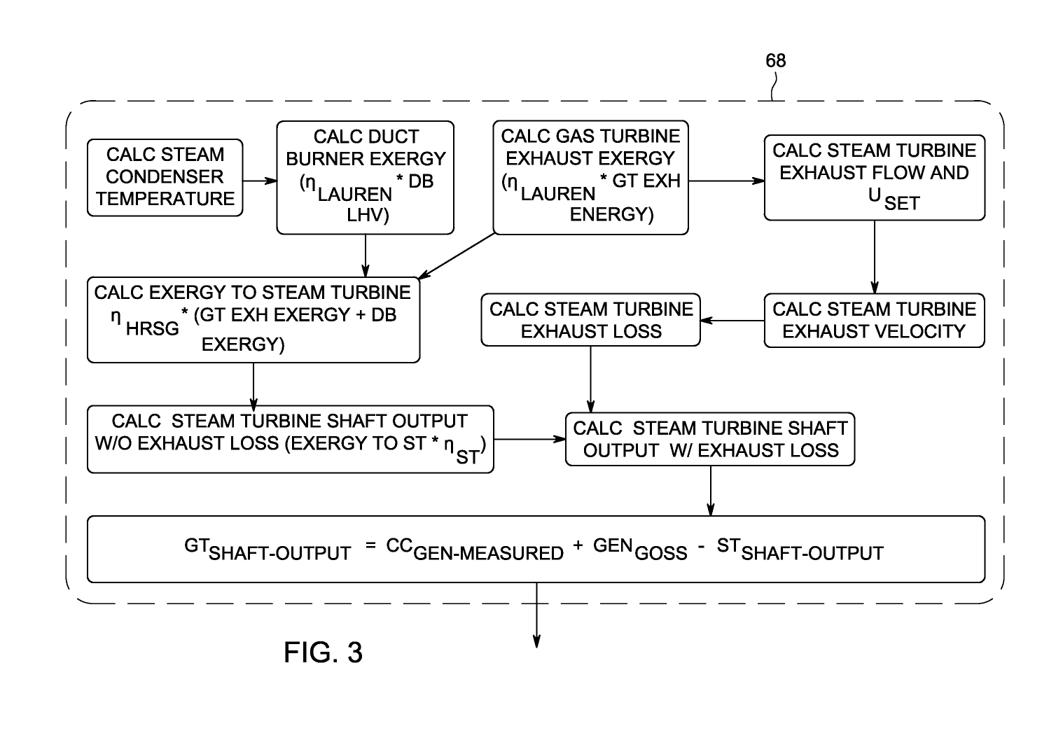

In accordance with an exemplary embodiment illustrated in FIG. 3, model 68 calculates, in less than twenty steps, how much of available exhaust energy from gas turbine portion 24 is passed to ST system 6. Model 68 employs a Lauren cycle ideal-gas conversion of exhaust energy from gas turbine portion 24 into available energy. Lauren cycle efficiency employs a hot source temperature (exhaust from gas turbine portion 24) and a reference cold sink temperature (saturated steam temperature from condenser 14). Saturated steam temperature from condenser 14 may be sensed, calculated from measured pressure, or predicted based on condenser type. Model 68 provides a substantially fully robust solution having an uncertainty of no more than 2%. The term “substantially fully robust” should be understood to describe that model 68 provides a solution nearly every time a model is calculated. In accordance with one aspect of the exemplary embodiment, model 68 provides a solution every time a model is calculated. In addition to being substantially fully robust, model 68 provides a solution in no more than 40 milliseconds. In accordance with an aspect of the exemplary embodiment, model 68 provides a solution in less than 1 millisecond.

In accordance with an exemplary embodiment, model 68 employs measured GT 4 system variables provided through one or more of sensors 72 and measured bottoming cycle variables provided through one or more of sensors 74. In accordance with an aspect of the exemplary embodiment, measured GT system 4 variables include, but are not limited to, a measured energy of exhaust gases passing from gas turbine portion 24. In accordance with another aspect of the exemplary embodiment, measured bottoming cycle parameters include, but are not limited to, generator output, exhaust temperature from gas turbine portion 24, condenser temperature, condenser pressure, ambient temperature, steam temperature passing to HP steam temperature, reheater (RH) steam temperature, HP steam pressure, HP bowl pressure, cold RH pressure, hot RH pressure, LP adm flow, and duct burner (DB) flow. Utilizing the above measured variables, in conjunction with various bottoming cycle configuration variables, model 68 calculates how much of the available energy from the exhaust gases flowing from gas turbine portion 24 is passed to ST system 6.

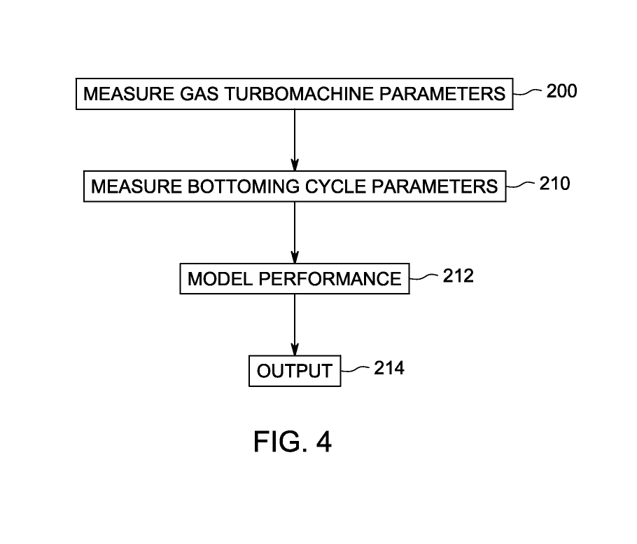

In accordance with another aspect of the exemplary embodiment, controller 60 measures parameters of gas turbine portion 24 as indicated in block 200 illustrated in FIG. 4. Controller also measures the bottoming cycle parameters as indicated in block 210. The measured parameters from gas turbine portion 24 and the measured bottoming cycle parameters are passed to model 68 in block 212. Model 68 utilizes the measured parameters from gas turbine portion 24, and the measured bottoming cycle parameters in conjunction with bottoming cycle configuration variables to form a model. In forming the model, model 68 separates HRSG 12 into two sections, an HP/IP section and a LP section, and calculates an efficiency for each section defining how much of the available energy from exhaust gases passing from gas turbine portion 24 is passed to ST system 6. The HRSG efficiencies are then combined with an efficiency of ST system 6, excluding last stage bucket turning and diffuser efficiency losses, to calculate how much of the available energy contained within the exhaust of gas turbine portion 24 is passed to ST system 6. The amount of available energy contained within the exhaust of gas turbine portion 24 passing to ST system 6 is provided as output in block 214. The output may be presented as information to operators, or could be employed by controller 60 to adjust operating parameters of CCPP 2.

As discussed above, the output from model 68 is substantially fully robust. Specifically, the lack of iterations ensures that model 68 provides a solution each time a model is run. Further, the particular calculation employed by model 68 ensures that a solution is provided in a very short time. In contrast to prior art systems, in which a solution may take as much as 1 minute or more to converge, if a convergence is achieved, model 68 provides a solution in approximately real time. In accordance with one aspect of an exemplary embodiment, convergence is achieved in no more than 40 milliseconds, often times the solution is provided in less than 1 millisecond. Thus, in addition to providing a solution every time, model 68 is on an order of 2500 times faster than prior art system. It should also be understood that, in addition to being provided in new combined cycle systems, the exemplary embodiment is easy to adapt or tune and thus may be readily incorporated or retrofit into existing combined cycle systems. Further, while describes as using condenser 14 as a cold sink reference, other cold sink temperatures could be utilized or condenser losses could be calculated explicitly. In addition, while described as employing a non-iterative model, the exemplary embodiment may employ a model having one or more iterations provided that the model converges to a result, as described above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A bottoming cycle modeling system for a combined cycle power plant, the system comprising:
one or more measurement devices configured and disposed to measure energy of exhaust gases passing from a gas turbine portion;
one or more measurement devices configured and disposed to measure at least one bottoming cycle parameter of the combined cycle power plant; and
a modeling system configured and disposed to calculate bottoming cycle performance based on the at least one output parameter of the gas turbine portion and the at least one bottoming cycle parameter, the modeling system employing a model that provides a substantially fully robust solution in approximately real time.

2. The system according to claim 1, wherein the model provides the substantially fully robust solution having an uncertainty of no more than 2%.

3. The system according to claim 2, wherein the model provides the substantially fully robust solution in less than 1 millisecond.

4. The system according to claim 1, wherein the model includes less than 20 steps.

5. The system according to claim 1, wherein the model comprises a non-iterative model.

6. The system according to claim 1, wherein the at least one bottoming cycle parameter includes measuring condenser pressure and condenser temperature.

7. A combined cycle power plant comprising:
a gas turbomachine (GT) system including a compressor portion and a gas turbine portion;
a steam turbomachine (ST) system including at least one steam turbine portion;
a heat recovery steam generator (HRSG) operatively connected to teach of the gas turbine portion and the at least one steam turbine portion; and
a controller operatively connected to each of the gas turbomachine, steam turbomachine, and the HRSG, the controller including a bottoming cycle modeling system comprising:
one or more measurement devices configured and disposed to measure energy of exhaust gases passing from a gas turbine portion;
one or more measurement devices configured and disposed to measure at least one bottoming cycle parameter; and
a modeling system configured and disposed to calculate bottoming cycle performance based on the at least one output parameter of the gas turbine portion and the at least one bottoming cycle parameter, the modeling system employing a model that provides a substantially fully robust solution in approximately real time.

8. The combined cycle power plant according to claim 7, wherein the model provides the substantially fully robust solution having an uncertainty of no more than 2%.

9. The combined cycle power plant according to claim 8, wherein the model provides the substantially fully robust solution in less than 1 millisecond.

10. The combined cycle power plant according to claim 7, wherein the model includes less than 20 steps.

11. The combined cycle power plant according to claim 7, wherein the model comprises a non-iterative model.

12. The combined cycle power plant according to claim 7, wherein the at least one bottoming cycle parameter includes measuring condenser pressure and condenser temperature.

13. The combined cycle power plant according to claim 7, wherein the gas turbine portion is mechanically linked to the at least one steam turbine portion.

14. The combined cycle power plant according to claim 13, wherein the gas turbine portion is mechanically linked to the at least one steam turbine portion through a generator.

15. A method of modeling bottoming cycle performance of a combined cycle power plant, the method comprising:
measuring energy of exhaust gases passing from a gas turbine portion;
measuring at least one bottoming cycle parameter of the combined cycle power plant; and
modeling bottoming cycle performance of the combined cycle power plant using a model that provides a substantially fully robust solution in approximately real time.

16. The method of claim 15, wherein modeling the bottoming cycle performance of the combined cycle power plant using the model includes using a non-iterative model.

17. The method of claim 15, wherein measuring the at least one bottoming cycle parameter of the combined cycle power plant includes measuring condenser pressure and condenser temperature.

18. The method of claim 15, further comprising: outputting a bottoming cycle performance result having an uncertainty of no more than 2% from the model.

19. The method of claim 18, further comprising: outputting the bottoming cycle performance result having an uncertainty of less than 2%.

20. The method of claim 15, further comprising modeling bottoming cycle performance in less than 20 calculation steps.
